(19) United States
(12) Patent Application Publication
(10) Pub. No.: US 2006/0294196 A1
(43) Pub. Date: Dec. 28, 2006

(54) Method and system for storing a web browser application session cookie from another client application program

(76) Inventors: Elie Feirouz, Brookline, MA (US); Doron Rosenberg, Austin, TX (US); Richard M. Wilson, Dover, NH (US); Darin W. Fisher, San Jose, CA (US)

Correspondence Address: LOTUS AND RATIONAL SOFTWARE;STEUBING MCGUINNESS, 125 NAGOG PARK, ACTON, MA, 01720, US

(21) Appl. No.: 11/167,787

(22) Filed: Jun. 27, 2005

(51) Int. Cl. G06F 15/16

(52) U.S. Cl. 709/217

(57) ABSTRACT

A system for storing a session cookie from another client application program, in which a separate client application is allowed to launch an external browser, and to supply a browser with a session cookie containing user specific session information. The browser is extended to support a new URI scheme providing for indication of a session cookie to be embedded into the browser, as well as an embedded URI to be processed by the browser after the indicated session cookie has been loaded into the browser. After the browser has been extended to handle the new URI scheme, a URI using the new scheme is passed to the browser as a command line parameter by a separate application program. The extended browser processes the new scheme URI, extracting the session cookie data and an embedded URI to be subsequently loaded. A client application separate from the browser may authenticate the user prior to the user requesting access to a secure Web page through the browser. The results of such background authentication steps, which are performed transparently with regard to the user, are then provided to the browser from the non-browser program, in order that the user need not re-supply them. Such previously obtained authentication credentials may be loaded by the non-browser application into the browser program on behalf of the user. Such user authentication credentials may be passed to the browser through a session cookie indicated to the browser using the new URI scheme disclosed herein.

### FIELD OF THE INVENTION

The present invention relates generally to network application programs, and more specifically to a method and system for storing a Web browser application session cookie from a separate client application program, such as a virtual desktop client application program. The present invention also provides a method and system for providing a pre-authenticated launch of a Web browser application from such a separate client application program.

### BACKGROUND OF THE INVENTION

As it is generally known, the World Wide Web (“Web”) is made up of Web servers computer systems that store and disseminate Web pages over Internet connections. Web pages are documents containing many types of content, such as text, graphics, animations and videos. Uniform Resource Locators (“URL”) are the most common addresses used to define a route to a Web page on a Web server.

A URL is a type of Uniform Resource Identifier (URI) that uses the Hypertext Transfer Protocol (HTTP). A URI is the general addressing technology for identifying resources on the Internet or a private intranet. The “scheme” of a given URI indicates the way a Web resource identified by the URI is to be used or accessed. A URI scheme is associated with a prefix, such as HTTP within a URL for accessing a designated Web resource using HTTP. The URI rules of syntax are set forth in the Internet Engineering Task Force (IETF) Request for Comments 1630, from which was derived URI Generic Syntax Request for Comments 2396.

Based on the contents of a provided URI, the browser application program renders Web pages on screen and automatically invokes additional software as needed. For example, animations and special effects are often presented using browser plug-in programs, and audio and video may be played by media player software that either comes with the operating system or from a third party.

A problem with existing systems occurs when a non-browser application program uses a browser program to access a Web page, in that user specific information previously obtained by the non-browser program may not be available to the service being accessed through desired Web page. For example, a user may begin a session with a non-browser application program, and during that session the non-browser program may collect various information regarding the user and the current session. Such user specific information may be used by the non-browser application program to provide a user experience customized to the user. However, if the non-browser program launches a browser program, for example in response to a user clicking on a hyperlink for a given URL, the user specific information for that user session is not accessible to the Web page(s) accessed by the browser. This results in a discontinuity of experience between when the user is using the non-browser client application, and when the user is accessing a Web page through the browser, even though the browser may have been launched through the non-browser program.

Another significant problem in existing systems occurs after a user has been authenticated through a non-browser client application program, and subsequently launches the browser through the non-browser application to access a secure Web page indicated by a URL. The user may be required to re-authenticate themselves by the secure Web page accessed through the browser, even through they may have already been authenticated for that page previously while using the non-browser application. The result is redundant authentication steps by the user, reducing the likelihood of a satisfactory user experience.

For the above reasons and others, it would be desirable to have a new system for making user specific session information accessible to Web pages accessed through a browser program launched from within a non-browser application program. The new system should further eliminate the need for redundant authentication steps by the user when accessing secure Web pages using the browser launched from within the non-browser application program.

### SUMMARY OF THE INVENTION

To address the above described and other shortcomings of previous systems, a method and system for storing a Web browser application session cookie from another client application program are disclosed. A separate client application is allowed to launch an external browser, and to supply the browser with a session cookie containing user specific session information.

In a first aspect of the disclosed system, the browser is extended to support a new URI scheme. The new URI scheme provides for indication of a name and value of a session cookie to be embedded into the browser, as well as an embedded URI to be processed by the browser after the session cookie has been embedded. After the browser has been extended to handle the new URI scheme, a URI using the new scheme is passed to the browser as a command line parameter by a separate application program. The disclosed system may use the browser's built-in inter-process communication mechanism to route the URI to a currently running browser instance, or may launch a new browser instance. In either case the URI may be passed as a command line parameter.

The extended browser processes the new scheme URI, extracting the session cookie data and an embedded URI to be subsequently loaded. A destination host is parsed from the embedded URI, and the extended browser loads the provided session cookie, for use in future operations, such as HTTP requests to the specified host during the current browser session. Finally, the extended browser loads the extracted URI.

In another aspect of the disclosed system, a client application separate from the browser may allow the user to access a secure Web site either by launching the browser from the non-browser application, or by using a currently running browser instance, without requiring that the user provide redundant authentication credentials. In this regard, the disclosed system operates to pre-authenticate the user prior to the user accessing the secure Web page through the browser. The results of such background authentication steps, which are performed transparently with regard to the user, are then provided to the browser from the non-browser program, in order that the user need not re-supply them. For example, a single sign on token or other information may be loaded by the non-browser application into the browser program on behalf of the user. Subsequently, when the user requests access to a secure Web page using the browser, they are granted access without having to re-authenticate. In one embodiment, user authentication credentials may be passed to the browser through a session cookie indicated to the browser using the new URI scheme disclosed herein. However, the disclosed system is not so limited, and any other appropriate mechanism may be used in the alternative to load the user's authentication credentials to the browser program.

The use of a session cookie by the disclosed system is advantageous for storing potentially sensitive user data in the browser, as opposed to using a persistent cookie, since it avoids the user data being written to disk, and allows for the deletion and expiration of the cookie to be intrinsically handled by the browser. This invention enables a session cookie to be embedded into a Web browser from a separate client application program. Moreover, the disclosed system enables this functionality independent of whether or not the browser is already running.

Thus there is disclosed a new system for making user specific session information accessible to Web pages accessed through a browser program launched from within a non-browser application program. The new system also eliminates the need for redundant authentication steps by the user when accessing secure Web pages using a browser launched from within the non-browser application program.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram illustrating hardware and software components in an illustrative embodiment;

FIG. 2 is a flow chart illustrating steps performed in a first aspect of the disclosed system in an illustrative embodiment;

FIG. 3 shows a URI scheme used in an illustrative embodiment;

FIG. 4 is a flow chart illustrating steps performed in a second aspect of the disclosed system in an illustrative embodiment;

FIG. 5 is a simplified screen shot of a user interface to an application program other than a Web browser application program in an illustrative embodiment, and including a number of hyperlinks; and

FIG. 6 is a simplified screen shot of a user interface to an application program other than a Web browser application after a user has clicked one of the hyperlinks shown in FIG. 5.

### DETAILED DESCRIPTION OF EXEMPLARY EMBODIMENTS

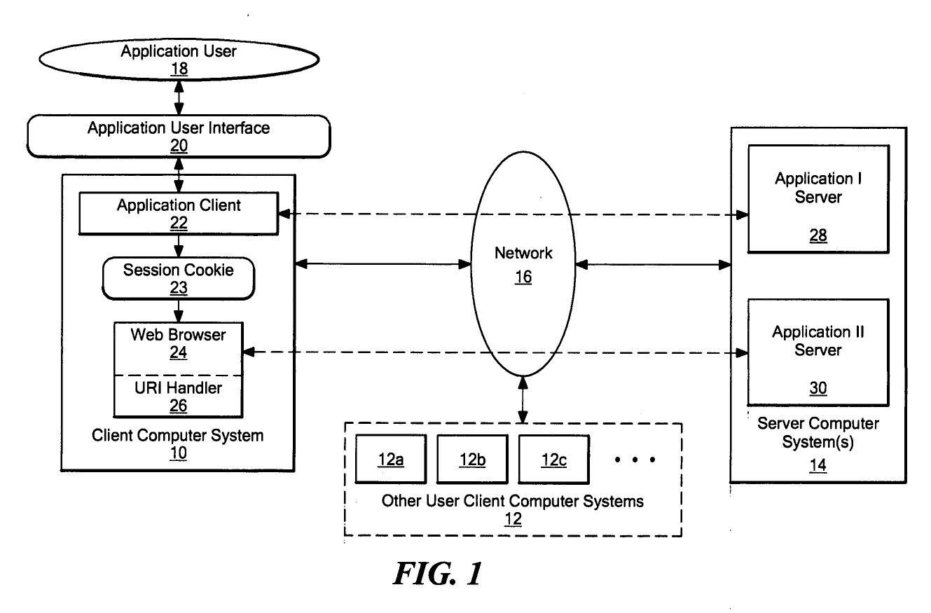

As shown in FIG. 1, in an embodiment of the disclosed system, a number of software components execute on various computer systems, shown for purposes of illustration in FIG. 1 including a client computer system 10 and other client computer systems 12, shown including a number of client computer systems 12a, 12b, 12c, etc., as well as one or more server computer systems 14. The client computer systems 10 and 12, and server computer system(s) 14 may, for example, each include at least one processor, program storage, such as memory, for storing program code executable on the processor, and one or more input/output devices and/or interfaces, such as data communication and/or peripheral devices and/or interfaces. The client computer systems 10 and 12 and server computer system(s) 14 are communicably connected by a data communication network 16, such as a Local Area Network (LAN), the Internet, or the like, which may also be connected to a number of other client and/or server computer systems. The client computer systems 10 and 12 and server computer system(s) 14 may further include appropriate operating system software.

As further shown in FIG. 1, an application user 18 is provided with an application user interface 20 by application client 22. The application user interface 20 may be any specific kind of user interface, such as a graphical user interface including graphical display objects such as buttons, menus, icons, etc. The application client 22 operates in cooperation with an application server program, shown for purposes of-illustration as the application I server 28. The application client 22 may be any specific kind of non-browser application program that processes data for the user 18. For example, the application client 22 may include spreadsheet, word processing, data management, presentation graphics, electronic mail, instant messaging, desktop publishing, personal information management, project management, computer aided design, mathematical, scientific, multi-media, and/or one or more other specific type of application program code.

During a user session in which the application user 18 uses the application client 22, the application client collects information regarding the session and/or application user 18. Such user information may, for example, include information such as password, single sign on (SSO) token, encrypted data, or any other type of application specific data. For example, a single sign on token may be generated using the application client 22 by way of an authentication process between the application client and software executing on the server computer system 14 that permits the application user 18 to enter one user name and password in order to access multiple applications. Such a single sign on may be requested at the initiation of the application user 18's session with application client 22, and may authenticate the application user 18 to access all the applications they have been given the rights to executing on the server computer system(s) 14, eliminating further authentication prompts when the user switches applications during that particular session. Credentials established for use by the application user 18 during such authentication steps may be stored as part of a single sign on token that may be subsequently used to authenticate the application user 18 on multiple application programs executing on server computer system(s) 14 during the current user session. Such credentials may, for example, include a user name, password, or any other specific kind of user authentication information, and may be encrypted in some embodiments.

The user information established by the application client 22 is passed a session cookie 22 to a Web browser 24. The session cookie 22 is relatively small data file that is temporarily stored on the client computer system 10 for the duration of the current user session. The session cookie 22 may be stored in memory, but not written permanently to a hard disk on the client compute system 22, as would be the case for a persistent cookie.

The session cookie 22 includes a range of URLs for which it is valid, such as all the Web pages within a given domain. After the session cookie 22 is passed to the Web browser 22, when the Web browser 22 sends an HTTP request or the like to a Web server including those URLs, it also sends along the session cookie. Accordingly, if the application user 18 indicates a secure Web page to be accessed, for example by clicking on a hyperlink within the application user interface 20 provided by the application client 22, the application client can invoke the Web browser 24 by passing the URL for that hyperlink to the Web browser 24. The Web browser 24 responds by sending an HTTP request for the secure Web page, and, in the case where the URL is within the range of URLs for the session cookie 23, includes both the URL and the session cookie 23 in the request. In this way, the user data collected by the application client 22 is seamlessly and transparently provided to the Web browser 24. After the session cookie 23 is passed to the Web browser 24, the Web browser 24 may assume control over the session cookie 23, and is responsible for deleting the session cookie 23 upon termination of the current user session, and/or termination of the use of Web browser 24 by the application user 18.

In one embodiment of the disclosed system, the session cookie 23, including user data collected by the application client 22, is passed from the application client 22 to the Web browser 24 using a URI having a format following a new URI scheme, as further described below. In such an embodiment, the URL of the desired Web page is passed to the Web browser 24 as an embedded URI within the URI conformant with the new URI scheme. The URI handler 26 of the Web browser 26 recognizes and processes the URI based on the new URI scheme, at least in part by storing an indication of the session cookie 23, and loading the embedded URI into the Web browser 26. This results in a request for the desired Web page being issued to a server system, with the request including the user data information from the session cookie 23.

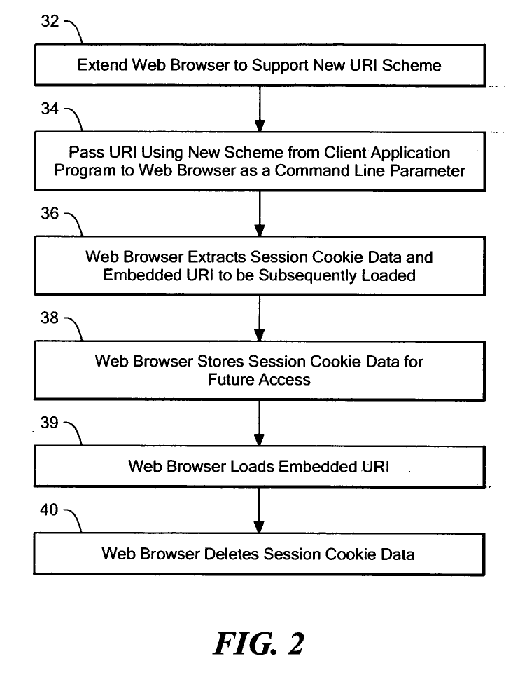

FIG. 2 is a flow chart illustrating steps performed by an illustrative embodiment of the disclosed system to pass user data from a client application program to a Web browser program. At step 32, the Web browser program is extended to handle a new URI scheme. The extension of the Web browser at step 32 may be accomplished in any specific manner, including, but not limited to, providing a plug-in or browser helper object (BHO) to the Web browser.

At step 34 the disclosed system passes a URI based on the new URI scheme from a client application program to the Web browser as a command line parameter. The URI based on the new URI scheme may, for example, be intercepted and processed by a URI handler routine that was part of the extension of the Web browser performed at step 32. At step 36, the extended Web browser extracts session cookie data and an embedded URI from the URI in the new URI scheme. The URI extracted from the URI in the new URI scheme is to be subsequently loaded into the Web browser program as a destination Web page to be requested.

The Web browser stores the session cookie data for future access at step 38. As noted above, the session cookie data may include any specific type of user data collected by the client application program passing the session cookie data to the Web browser. At step 39, the embedded URI that was extracted at step 36 is loaded into the Web browser. For example, the embedded URI loaded at step 39 may be a URL of a Web page that was requested by a user of the client application program that previously passed the session cookie to the Web browser. As a result of the loading of the embedded URI at step 39, the Web browser may, for example, issue an HTTP request for the Web page identified by the embedded URI, and also including user data information from the session cookie data extracted at step 36. At step 40, the Web browser detects that the current user session has terminated, and deletes the session cookie data extracted at step 36. Thus the information passed in the session cookie data is not persistent, in that it is not stored to hard disk at the end of the user session.

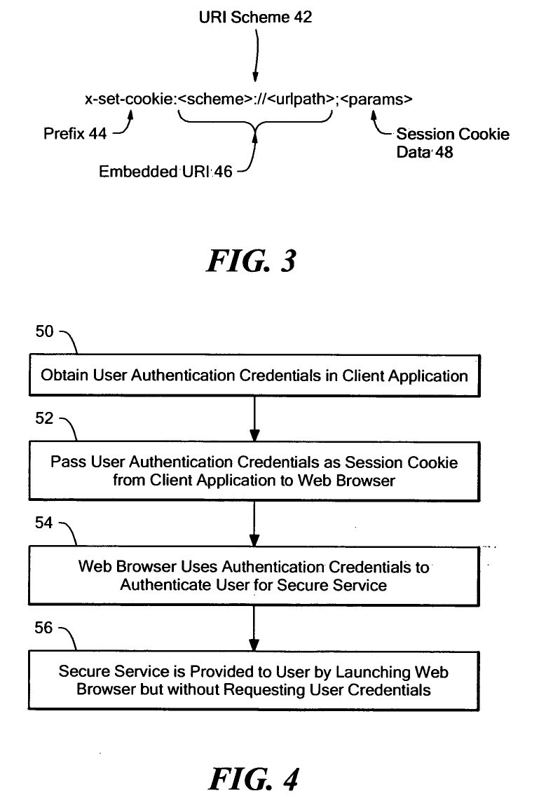

FIG. 3 shows an example embodiment of the disclosed URI scheme 42. The URI scheme 42 is conformant with the rules of syntax set forth in the Internet Engineering Task Force (IETF) Request for Comments 2396, which was derived from URI Generic Syntax Request for Comments 1630. As shown in FIG. 3, the URI scheme 42 includes a prefix 44, shown for purposes of illustration and explanation as the string “x-set-cookie”, which indicates that the remainder of the URI follows the format for the new URI scheme. Those skilled in the art will recognize that the string “x-set-cookie”. is only one possible prefix that may be used in this regard, and that any other prefix that does not conflict with any previously defined prefix may be used in the alternative or in addition in this regard.

The URI scheme 42 is shown further including an embedded URI 46. The embedded URI 46 may, for example, consist of a URL having a <scheme> value equal to “https”, and a <urlpath> indicating a Web page. Additionally, the URI scheme 42 includes session cookie data 48, which stores user data to be used when accessing the resource indicated by the embedded URI 46. One example of a URI conformant with the new URI scheme 42 is as follows:

x-set-cookie:https://www.abz.com/root/profile;SSOToken=ssotokevalue

where the embedded URI value is the path “https://www.abz.com/root/profile”, and the session cookie data is the name value pair “SSOToken=ssotokenvalue”, for example indicating a name and value of a single sign on token to be used when accessing the path in the embedded URI.

Pre-Authenticated Browser Launch

FIG. 4 shows steps performed by the disclosed system to perform a pre-authenticated browser launch from a client application program. As shown in step 50, the client application program obtains user authentication credentials during interactions with the user of the client application program. At step 52, the user authentication credentials are passed as a session cookie from the client application program to the, Web browser. The Web browser then uses the authentication credentials from the session cookie to authenticate the user for a secure services, such as a service provided through a secure Web page, at step 54. Without requiring the user to re-authenticate, the secure service can then be provided through the Web browser at step 56.

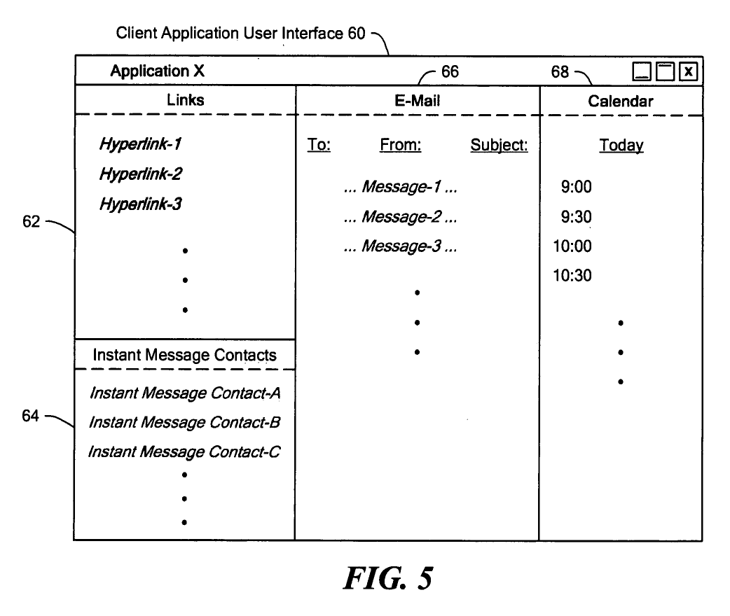

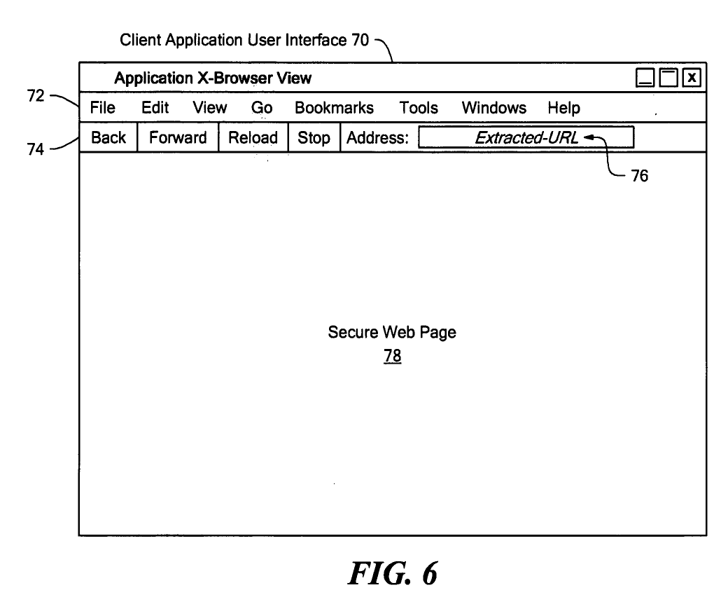

FIG. 5 is a simplified screen shot illustrating an example of a client application user interface 60 in an embodiment of the disclosed system. As shown in FIG. 5, the client application user interface 60 includes a links region 62 including a number of hyperlinks, some of which may be associated with secure Web pages. The client application user interface 60 further includes a number of other regions providing user access to a corresponding number of services, shown for purposes of illustration as including a messaging region 64 displaying a number of instant messaging contacts, an email region 66 displaying a number of email messages, and a calendar region showing a number of appointments for the user. Those skilled in the art will recognize that the specific services shown in the example of FIG. 5 are only some of the possible services that may be provided through a user interface to an application client program, and that the present invention is not limited to those shown in FIG. 5. Accordingly, the present invention may be embodied through any specific type or kind of client application user interface that includes hyperlinks or the like allowing a user to indicate a desired service or Web page. In response to the user selecting such a service or Web page, for example by clicking on one of the hyperlinks in the links region 62, the disclosed system invokes a Web browser program to access the desired service or Web page. If the desired service or Web page is secure, the disclosed system may pre-authenticate the user by passing, user data including authentication credentials to the secure service or Web page transparently to the user, within a session cookie, so that the desired service or Web page is provided to the user without the user having to re-authenticate. The result of such a pre-authenticated access is shown in FIG. 6.

FIG. 6 shows a client application user interface 70, providing a secure Web page 78 to a user that has been pre-authenticated by an embodiment of the disclosed system. As shown in the example of FIG. 6, the secure Web page 78 may be provided within a client application user interface 70 associated with and provided through an application client program separate from the Web browser program. The client application user interface 70 includes a row 50 of pull down menus commonly associated with Web browser functions, and a row 74 of button display objects also associated with common Web browser functions. In one embodiment, the location of the secure Web page 78 is determined by extracting a URL 76 from a URI in a new URI scheme to the Web browser, as described above. However, other techniques may alternatively be used to pass a session cookie including the URL of the secure Web page 78 to the Web browser program.

Those skilled in the art will recognize that FIGS. 3-7 are simplified screen shots provided for illustrative and explanatory purposes only, and that the present invention may be embodied using various specific user interface screens, forms, and/or display objects to provide the functions described. Moreover, while the description of the preferred embodiments includes reference to button graphical display objects for triggering certain operations, the disclosed system is not limited to such embodiments, and other types of user interface display objects, menus, techniques and/or mechanisms may be used in the alternative.

FIGS. 1, 2 and 4 are block diagram and flowchart illustrations of methods, apparatus(s) and computer program products according to an embodiment of the invention. It will be understood that each block of FIGS. 1, 2 and 4, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative program command structures, one skilled in the art will recognize that they may be embodied using a variety of specific command structures.

We claim:

1. A method for providing user access to a Web browser application program, comprising:
extending said Web browser application program to process an enhanced uniform resource identifier scheme, wherein said enhanced uniform resource identifier scheme defines a session cookie parameter and an embedded uniform resource identifier part;
receiving user data by an application program other than said Web browser application program;
receiving, by said application program other than said Web browser application program, a user indication that said Web browser application program is to be used to access a desired resource; and
forming, by said application program other than said Web browser application program, a uniform resource identifier consistent with said enhanced uniform resource identifier scheme, wherein said uniform resource identifier includes a session cookie parameter identifying said user data and an embedded uniform resource identifier identifying said desired resource.

2. The method of claim 1, further comprising passing said uniform resource identifier consistent with said enhanced uniform resource identifier scheme from said application program other than said Web browser application program to said Web browser application program.

3. The method of claim 2, further comprising processing said uniform resource identifier consistent with said enhanced uniform resource identifier scheme in said Web browser application program, wherein said processing includes storing said session cookie parameter identifying said user data for future reference by said Web browser application program, and accessing said desired resource based on said embedded resource identifier identifying said desired resource.

4. The method of claim 3, wherein said Web browser application program references and uses said user data identified by said session cookie while accessing said desired resource.

5. The method of claim 1, wherein said user data comprises at least one user authentication credential.

6. The method of claim 5, wherein said at least one user authentication credential comprises a password.

7. The method of claim 5, wherein said at least one user authentication credential comprises a single sign on token.

8. The method of claim 1, wherein said user data comprises encrypted user data.

9. The method of claim 4, further comprising said Web browser application program deleting said session cookie in response to detection that a user session has ended.

10. A system having a computer readable medium, said computer readable medium having program code for providing user access to a Web browser application program stored thereon, said program code comprising:
program code for extending said Web browser application program to process an enhanced uniform resource identifier scheme, wherein said enhanced uniform resource identifier scheme defines a session cookie parameter and an embedded uniform resource identifier part;
program code for receiving user data by an application program other than said Web browser application program;
program code for receiving, by said application program other than said Web browser application program, a user indication that said Web browser application program is to be used to access a desired resource; and
program code for forming, by said application program other than said Web browser application program, a uniform resource identifier consistent with said enhanced uniform resource identifier scheme, wherein said uniform resource identifier includes a session cookie parameter identifying said user data and an embedded uniform resource identifier identifying said desired resource.

11. The system of claim 10, further comprising program code for passing said uniform resource identifier consistent with said enhanced uniform resource identifier scheme from said application program other than said Web browser application program to said Web browser application program.

12. The system of claim 11, further comprising program code for processing said uniform resource identifier consistent with said enhanced uniform resource identifier scheme in said Web browser application program, wherein said processing includes storing said session cookie parameter identifying said user data for future reference by said Web browser application program, and accessing said desired resource based on said embedded resource identifier identifying said desired resource.

13. The system of claim 12, wherein said Web browser application program references and uses said user data identified by said session cookie while accessing said desired resource.

14. The system of claim 10, wherein said user data comprises at least one user authentication credential.

15. The system of claim 14, wherein said at least one user authentication credential comprises a password.

16. The system of claim 14, wherein said at least one user authentication credential comprises a single sign on token.

17. The system of claim 10, wherein said user data comprises encrypted user data.

18. The system of claim 13, further comprising said Web browser application program deleting said session cookie in response to detection that a user session has ended.

19. A computer program product having a computer readable medium, said computer readable medium having program code for providing user access to a Web browser application program stored thereon, said program code comprising:
program code for extending said Web browser application program to process an enhanced uniform resource identifier scheme, wherein said enhanced uniform resource identifier scheme defines a session cookie parameter and an embedded uniform resource identifier part;
program code for receiving user data by an application program other than said Web browser application program;
program code for receiving, by said application program other than said Web browser application program, a user indication that said Web browser application program is to be used to access a desired resource; and
program code for forming, by said application program other than said Web browser application program, a uniform resource identifier consistent with said enhanced uniform resource identifier scheme, wherein said uniform resource identifier includes a session cookie parameter identifying said user data and an embedded uniform resource identifier identifying said desired resource.

20. A computer data signal embodied in a carrier wave, said computer data signal including a program code for providing user access to a Web browser application program, said program code comprising:
program code for extending said Web browser application program to process an enhanced uniform resource identifier scheme, wherein said enhanced uniform resource identifier scheme defines a session cookie parameter and an embedded uniform resource identifier part;
program code for receiving user data by an application program other than said Web browser application program;
program code for receiving, by said application program other than said Web browser application program, a user indication that said Web browser application program is to be used to access a desired resource; and
program code for forming, by said application program other than said Web browser application program, a uniform resource identifier consistent with said enhanced uniform resource identifier scheme, wherein said uniform resource identifier includes a session cookie parameter identifying said user data and an embedded uniform resource identifier identifying said desired resource.

21. A system for providing user access to a Web browser application program, comprising:
means for extending said Web browser application program to process an enhanced uniform resource identifier scheme, wherein said enhanced uniform resource identifier scheme defines a session cookie parameter and an embedded uniform resource identifier part;
means for receiving user data by an application program other than said Web browser application program;
means for receiving, by said application program other than said Web browser application program, a user indication that said Web browser application program is to be used to access a desired resource; and
means for forming, by said application program other than said Web browser application program, a uniform resource identifier consistent with said enhanced uniform resource identifier scheme, wherein said uniform resource identifier includes a session cookie parameter identifying said user data and an embedded uniform resource identifier identifying said desired resource.

22. A method for providing user access to a secure resource through a Web browser application program, comprising:
authenticating said user at a secure resource by an application program other than said Web browser application program, wherein said authenticating is transparent to said user, wherein said authenticating involves at least one authentication credential of said user;
receiving, by said application program other than said Web browser application program, a user indication that said Web browser application program is to be used to access said secure resource; and
providing said authentication credential of said user from said application program other than said Web browser application program to said Web browser application program in a session cookie for use when accessing said secure resource.

23. The method of claim 22, wherein said authentication credential comprises a single sign on token.

24. The method of claim 22, wherein said authentication credential comprises a password.

25. The method of claim 22, further comprising:
providing a hyperlink to said secure resource in a user interface provided by said application program other than said Web application program; and
wherein said user indication that said Web browser application program is to be used to access said secure resource includes detection of said user clicking on said hyperlink.

26. The method of claim 22, wherein said providing said authentication credential of said user from said application program other than said Web browser application program comprises passing a session cookie data structure containing said authentication credential to said Web browser application program.

27. A system including a computer readable medium, said computer readable medium having program code stored thereon for providing user access to a secure resource through a Web browser application program, said program code comprising:
program code for authenticating said user at a secure resource by an application program other than said Web browser application program, wherein said authenticating is transparent to said user, wherein said authenticating involves at least one authentication credential of said user;
program code for receiving, by said application program other than said Web browser application program, a user indication that said Web browser application program is to be used to access said secure resource; and
program code for providing said authentication credential of said user from said application program other than said Web browser application program to said Web browser application program in a session cookie for use when accessing said secure resource.

28. The system of claim 27, wherein said authentication credential comprises a single sign on token.

29. The system of claim 27, wherein said authentication credential comprises a password.

30. The system of claim 27, further comprising:
program code for providing a hyperlink to said secure resource in a user interface provided by said application program other than said Web application program; and
wherein said user indication that said Web browser application program is to be used to access said secure resource includes detection of said user clicking on said hyperlink.

31. The system of claim 27, wherein said program code for providing said authentication credential of said user from said application program other than said Web browser application program comprises program code for passing a session cookie data structure containing said authentication credential to said Web browser application program.

32. A computer program product including a computer readable medium, said computer readable medium having program code stored thereon for providing user access to a secure resource through a Web browser application program, said program code comprising:
program code for authenticating said user at a secure resource by an application program other than said Web browser application program, wherein said authenticating is transparent to said user, wherein said authenticating involves at least one authentication credential of said user;
program code for receiving, by said application program other than said Web browser application program, a user indication that said Web browser application program is to be used to access said secure resource; and
program code for providing said authentication credential of said user from said application program other than said Web browser application program to said Web browser application program in a session cookie for use when accessing said secure resource.

33. A computer data signal embodied in a carrier wave, said computer data signal including program code for providing user access to a secure resource through a Web browser application program, said program code comprising:
program code for authenticating said user at a secure resource by an application program other than said Web browser application program, wherein said authenticating is transparent to said user, wherein said authenticating involves at least one authentication credential of said user;
program code for receiving, by said application program other than said Web browser application program, a user indication that said Web browser application program is to be used to access said secure resource; and
program code for providing said authentication credential of said user from said application program other than said Web browser application program to said Web browser application program for use when accessing said secure resource.

34. A system for providing user access to a secure resource through a Web browser application program, comprising:
means for authenticating said user at a secure resource by an application program other than said Web browser application program, wherein said authenticating is transparent to said user, wherein said authenticating involves at least one authentication credential of said user;
means for receiving, by said application program other than said Web browser application program, a user indication that said Web browser application program is to be used to access said secure resource; and
means for providing said authentication credential of said user from said application program other than said Web browser application program to said Web browser application program for use when accessing said secure resource.
